(19) United States
(12) Patent Application Publication
(10) Pub. No.: US 2018/0326900 A1
(43) Pub. Date: Nov. 15, 2018

(54) MULTIFUNCTION VEHICLE INTERIOR LIGHT WITH SWITCHABLE BEAM PATTERN AND CHANGEABLE COLOR

(71) Applicant: Ford Global Technologies, LLC, Dearborn, MI (US)

(72) Inventors: Linsheng Chen, Woodbury, MN (US); Steven J. Antilla, Brighton, MI (US)

(73) Assignee: Ford Global Technologies, LLC

(21) Appl. No.: 15/591,192

(22) Filed: May 10, 2017

(51) Int. Cl. B60Q 3/76; B60Q 3/74; F21V 14/00; H05B 33/08; F21V 14/08; B60Q 3/51; F21V 14/02; B60Q 3/85; B60Q 3/66

(52) U.S. Cl. CPC B60Q 3/76; B60Q 3/74; F21V 14/003; H05B 33/0863; F21Y 2115/10; B60Q 3/51; F21V 14/02; B60Q 3/85; B60Q 3/66; F21V 14/08

(57) ABSTRACT

A vehicle comprises: an interior; a light assembly capable of emitting light with both a first beam pattern and a second beam pattern to the interior, the light assembly comprising a light source, capable of emitting light in multiple colors, that emits light that exits the light assembly and enters the interior of the vehicle with either the first beam pattern or the second beam pattern; and a controller that controls whether the light that exists the light assembly and enters the interior of the vehicle has either the first beam pattern or the second beam pattern and controls which color of the multiple colors the light source emits. The vehicle can further comprise a user interface in communication with the controller, wherein the user interface is usable from the interior and allows a passenger of the vehicle to select a color of the multiple colors of the light.

### FIELD OF THE INVENTION

The present invention generally relates to interior vehicle lighting.

### BACKGROUND OF THE INVENTION

A vehicle typically has interior lights. However, the interior lights can be expensive and occupy too much space.

### SUMMARY OF THE INVENTION

According to a first aspect of the present invention, a light assembly for emitting light into an interior of a vehicle comprises: a light source capable of emitting light of more than one color; an optical device in optical relation to the light source such that the light transmits through or within the optical device; the light source having a first position relative to the optical device such that the light transmitted through the optical device leaves the optical device with a first beam pattern; and the light source having a second position relative to the optical device such that the light transmitted through or within the optical device leaves the optical device with a second beam pattern.

Embodiments of the first aspect of the invention can include any one or a combination of the following features:
The light source is one or more LEDs;
In the first position, the light leaving the optical device serves as light for reading; and
In the second position, the light leaving the optical device serves as ambient lighting.

According to a second aspect of the present invention, a light assembly for emitting light into an interior of a vehicle comprises: a light source capable of emitting light of more than one color; an optical device in optical relation to the light source such that the light transmits through or within the optical device and leaves the optical device with a first beam pattern; an electrically controllable light scattering device in optical relation to the optical device such that the light that has left the optical device with the first beam pattern transmits through the electrically controllable light scattering device; wherein the electrically controllable light scattering device has a light scattering state and a non-light scattering state; wherein, in the non-light scattering state, the electrically controllable light scattering device allows the light that transmits through the electrically controllable light scattering device to leave the electrically controllable light scattering device with the first beam pattern; wherein, in the light scattering state, the electrically controllable light scattering device causes the light that transmits through the electrically controllable light scattering device to leave the electrically controllable light scattering device with a second beam pattern.

Embodiments of the second aspect of the invention can include any one or a combination of the following features:
Wherein the electrically controllable light scattering device is a polymer dispersed liquid crystal device; wherein in the non-light scattering state, an electrical potential is applied to the polymer dispersed liquid crystal device; and wherein in the light scattering state, an electrical potential is not applied to the polymer dispersed liquid crystal device;
In the non-light scattering state, the light leaving the polymer dispersed liquid crystal device serves as light for reading;
In the light scattering state, the light leaving the polymer dispersed liquid crystal device serves as ambient light; and
The light source is one or more LEDs.

According to a third aspect of the present invention, a vehicle comprises an interior; a light assembly capable of emitting light with both a first beam pattern and a second beam pattern to the interior, the light assembly comprising a light source, capable of emitting light in multiple colors, that emits light that exits the light assembly and enters the interior of the vehicle with either the first beam pattern or the second beam pattern; and a controller that controls whether the light that exists the light assembly and enters the interior of the vehicle has either the first beam pattern or the second beam pattern and controls which color of the multiple colors the light source emits.

Embodiments of the third aspect of the invention can include any one or a combination of the following features:
The vehicle further comprises a user interface in communication with the controller, wherein the user interface is usable from the interior and allows a passenger of the vehicle to select a color of the multiple colors of the light;
The user interface further allows the passenger to select whether the light enters the interior with the first beam pattern or with the second beam pattern;
The vehicle is transporting a passenger autonomously, and the light that enters the interior of the vehicle is in the first beam pattern for purposes of providing light for the passenger to read;
The light source is one or more LEDs;
The optical device is a lens;
The one or more LEDs include one or more RGB LEDs;
The interior of the vehicle comprising a ceiling, wherein the light source is positioned at the ceiling;
The light assembly further comprises: an optical device in optical relation to the light source such that the light transmits through or within the optical device; the light source having a first position relative to the optical device such that the light transmitted through or within the optical device leaves the optical device with the first beam pattern; and the light source having a second position relative to the optical device such that the light transmitted through or within the optical device leaves the optical device with the second beam pattern that is wider than compared to the first beam pattern; wherein the controller controls whether the light source is in the first position or the second position based on a selection made on the user interface as to whether the light enters the interior with the first beam pattern or with the second beam pattern;
The light assembly further comprises: an optical device in optical relation to the light source such that the light transmits through or within the optical device and leaves the optical device with the first beam pattern; an electrically controllable light scattering device in optical relation to the optical device such that the light that has left the optical device with the first beam pattern transmits through the electrically controllable light scattering device; wherein the electrically controllable light scattering device has a light scattering state and a non-light scattering state; wherein, in the non-light scattering state, the electrically controllable light scattering device allows the light that transmits through the electrically controllable light scattering device to leave the electrically controllable light scattering device with the first beam pattern; wherein, in the light scattering state, the electrically controllable light scattering device causes the light that transmits through the electrically controllable light scattering device to leave the electrically controllable light scattering device with the second beam pattern; and wherein the controller controls whether the electrically controllable light scattering device is in the non-light scattering state or the light scattering state based on a selection made on the user interface as to whether the light enters the interior with the first beam pattern or with the second beam pattern; and
The electrically controllable light scattering device is a polymer dispersed liquid crystal device.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective view of an interior of a vehicle, illustrating a light assembly at the ceiling;

FIG. 2 is a perspective view of the interior of FIG. 1, illustrating a user interface to control the light assembly;

FIG. 3 is a schematic view of the light assembly of FIG. 1, illustrating a light source in a first position relative to an optical device and emitting light that leaves a optical device with a first beam pattern;

FIG. 4 is a schematic view of the light assembly of FIG. 1, illustrating the light source in a second position relative to the optical device and emitting light that leaves the optical device with a second beam pattern;

FIG. 5 is a schematic view of an alternative embodiment of the light assembly of FIG. 1, illustrating an electrically controllable light scattering device in a non-light scattering state that does not alter the first beam pattern;

FIG. 6 is a schematic view of the alternative embodiment of FIG. 5, illustrating the electrically controllable light scattering device in a light scattering state that alters the first beam pattern in to a second beam pattern;

FIG. 7 is a schematic view of an embodiment of the electrically controllable light scattering device of FIG. 6, namely a polymer dispersed liquid crystal device, in a non-light scattering state;

FIG. 8 is a schematic view of the polymer dispersed liquid crystal device of FIG. 7 in a light scattering state;

FIG. 9 is a diagram illustrating the controller for the light assembly of FIG. 1 or the alternative embodiment of FIG. 5 using the user interface as input;

FIG. 10 is a top view of the user interface of FIG. 2, illustrating graphical representations of color choice and beam pattern for the user to select to control the light assembly of FIG. 1 or FIG. 5; and

FIG. 11 is a flow chart for a light assembly control routine used by the controller of FIG. 9.

### DETAILED DESCRIPTION OF THE PREFERRED EMBODIMENTS

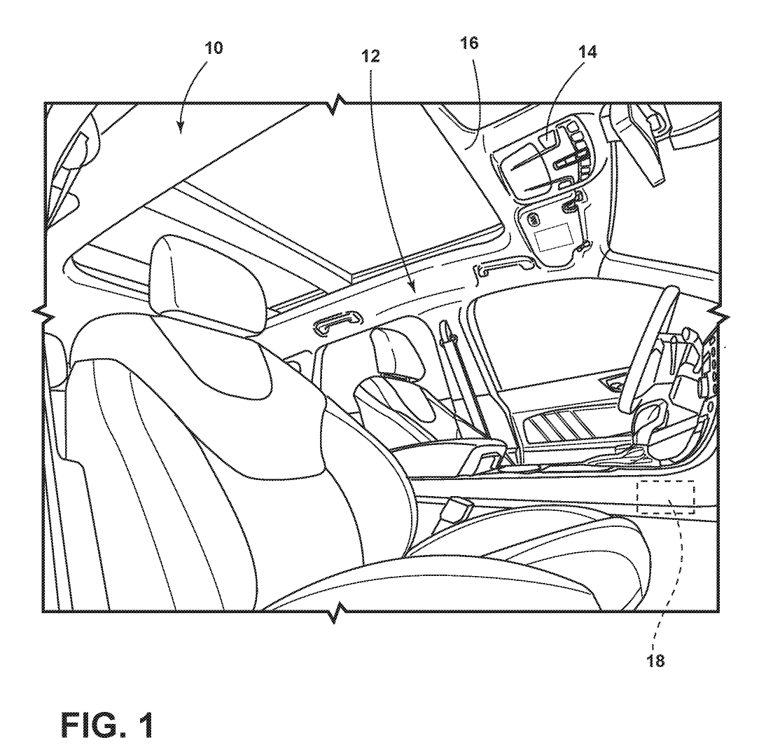

For purposes of description herein, the terms “upper,” “lower,” “right,” “left,” “rear,” “front,” “vertical,” “horizontal,” and derivatives thereof shall relate to the disclosure as oriented in FIG. 1. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

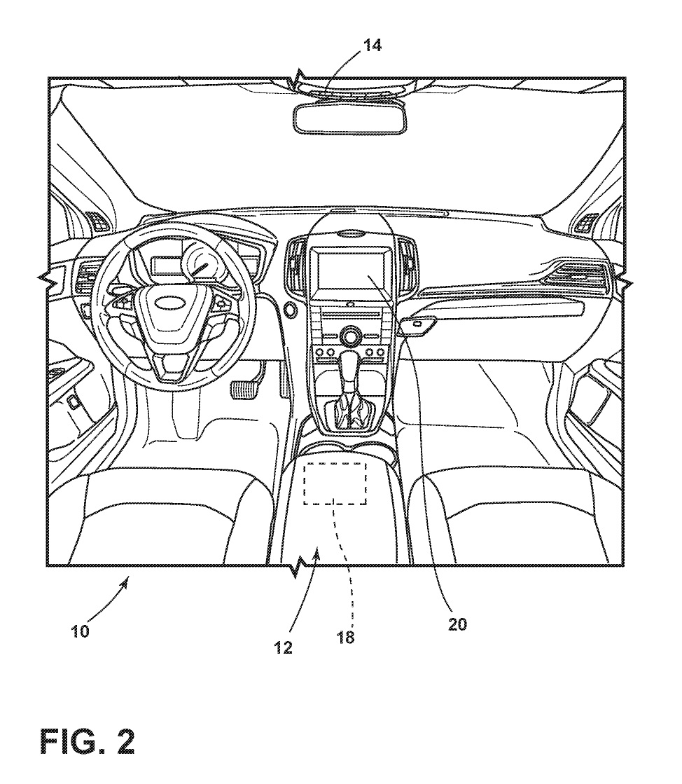

Referring to FIGS. 1-2, a vehicle 10 includes an interior 12 and a light assembly 14 for emitting light into the interior 12 of the vehicle 10. The interior 12 of the vehicle 10 has a ceiling 16. The light assembly 14 could be positioned at the ceiling 16 so that emitted light shines generally down into the interior 12 of the vehicle 10. The vehicle further includes a controller 18, which can control the operation of the light assembly 14, as discussed below. The vehicle 10 further includes a user interface 20 in communication with the controller 18. The user interface 20 is usable from the interior 12. The user interface 20 allows a passenger to control the operation of the light assembly 14. The vehicle 10 can be an autonomous vehicle or a human operated vehicle, and can be a car, truck, or van, among other vehicles.

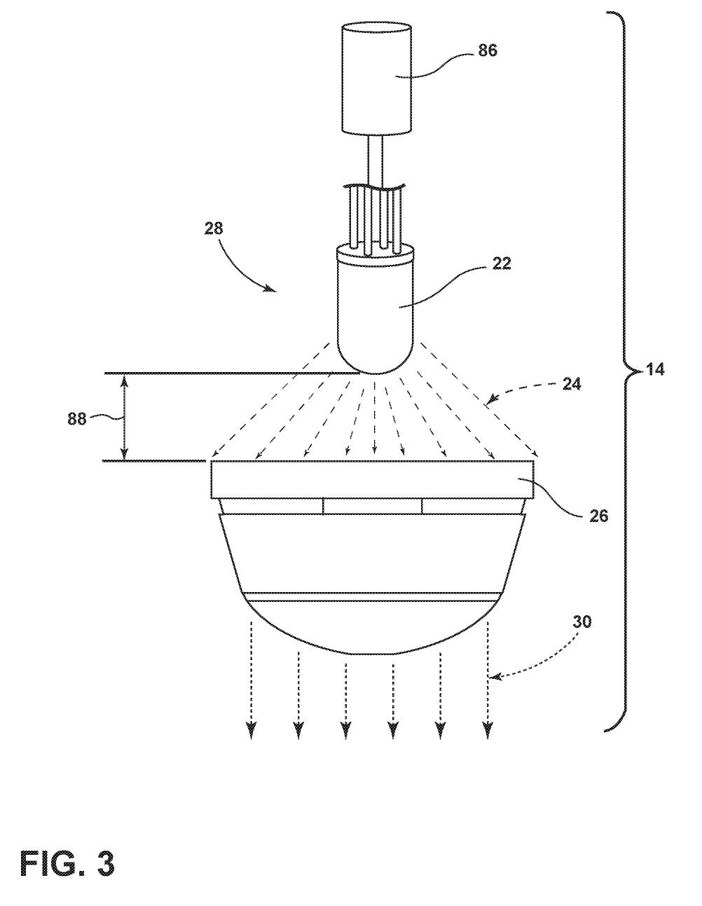

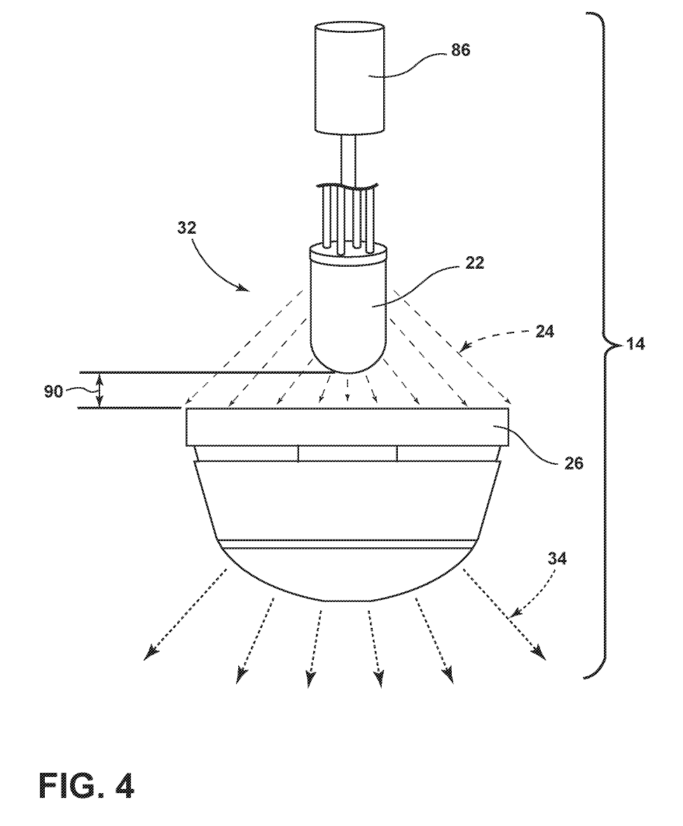

Referring to FIGS. 3-4, the light assembly 14 includes a light source 22. The light source 22 is capable of emitting light 24. The light assembly 14 further includes an optical device 26. The optical device 26 is in optical relation to the light source 22, meaning that the light 24 that the light source 22 emits reaches and transmits through or within the optical device 26. The optical device 26 can be a lens, a reflector, or a light pipe (solid or hollow), among other things. In other words, the optical device 26 can guide and manipulate the light 24 that the light source 22 emits. The light source 22 has a first position 28 relative to the optical device 26 defined by a first distance 88 between the light source 22 and the optical device 26 (see FIG. 3). In this first position 28, the light 24 transmitted through the optical device 26 leaves the optical device 26 with a first beam pattern 30, which can be a narrower and/or a more collimated pattern compared to a second beam pattern 34 discussed below. In the first position 28, the light 24 leaving the optical device 26 serves as light for reading. For example, the light 24 leaving the optical device 26 is sufficiently narrow to allow a passenger of the vehicle 10 to read a map, a display screen on a computing device, a book, and any other material that the passenger desires to read.

The light source 22 has a second position 32 relative to the optical device 26 defined by a second distance 90 (different than the first distance 88) between the light source 22 and the optical device 26 (see FIG. 4). In other words, in the second position 32, the light source 22 is either closer to the optical device 26 or further away from the optical device 26 than in the first position 28, whichever provides the desired change in beam pattern taking into account the specific optical device 26 used. In the second position 32, the light 24 transmitted through the optical device 26 leaves the optical device 26 in a second beam pattern 34, which can be wider and/or less collimated beam pattern, than compared to the first beam pattern 30. In the second position 32, the light 24 leaving the optical device 26 serves as ambient lighting and is less suitable for reading. The ambient lighting, such as through the emittance of a desired color of diffused light, can assist in setting the mood, perception, and feeling for passengers of the vehicle 10. The light source 22 can transition between the first position 28 and the second position 32. A movement device 86 attached to the light source 22, such as a motor or piston, in communication with the controller 18, causes the light source 22 to move between and be in either the first position 28 or the second position 32.

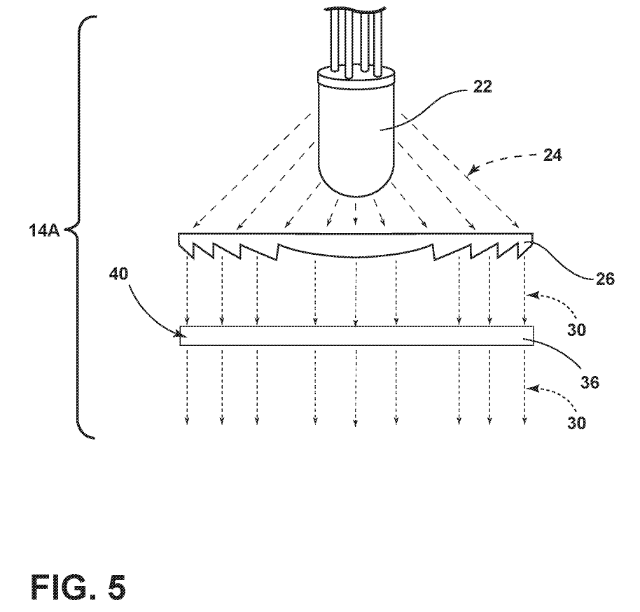

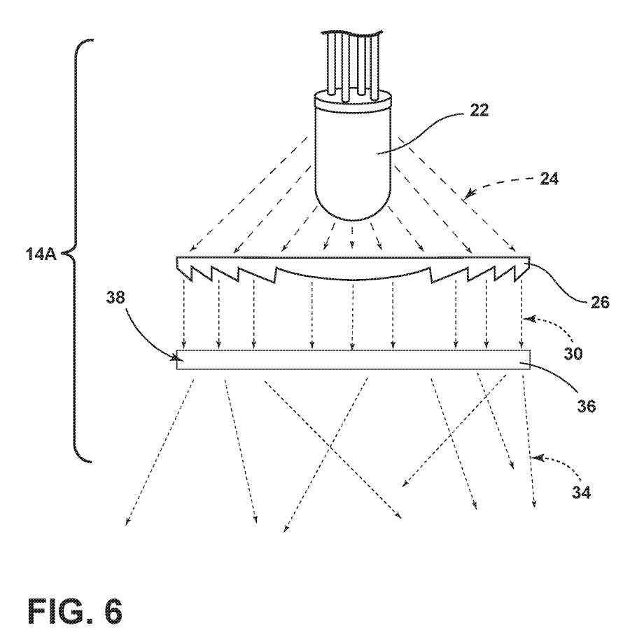

Referring to FIGS. 5-6, an alternative embodiment of the light assembly 14, namely light assembly 14A, is illustrated. The light assembly 14A again includes the light source 22. The light source 22 is again capable of emitting light 24 of more than one color. The light assembly 14A further includes the optical device 26 (which can be a different type of optical device than the optical device 26 used with light assembly 14, such as a Fresnel lens) in optical relation to the light source 22, such that the light 24 transmits through the optical device 26 and leaves the optical device 26 with a first beam pattern 30, which again can be a narrower and/or more collimated pattern. The light assembly 14A further includes an electrically controllable light scattering device 36. An electrically controllable light scattering device is a device that can alter the beam pattern of an incoming light upon an electrically communicated command, and includes a device such as a polymer dispersed liquid crystal device. The electrically controllable light scattering device 36 is in optical relation to the optical device 26 such that the light 24 that has left the optical device 26 in the first beam pattern 30 transmits through the electrically controllable light scattering device 36. The electrically controllable light scattering device 36 has a light scattering state 38 and a non-light scattering state 40. In the non-light scattering state 40 (see FIG. 5), the electrically controllable light scattering device 36 allows the light 24 that transmits through the electrically controllable light scattering device 36 to leave the electrically controllable light scattering device 36 essentially with the first beam pattern 30. In other words, in the non-light scattering state 40, the electrically controllable light scattering device 36 does not purposefully alter the beam pattern of the light 24 entering the electrically controllable light scattering device 36 from the first beam pattern 30. However, in the light scattering state 38 (see FIG. 6), the electrically controllable light scattering device 36 causes the light 24 that transmits through the electrically controllable light scattering device 36 to leave the electrically controllable light scattering device 36 in a second beam pattern 34, which again is a wider and/or less collimated and/or more diffused (scattered) beam pattern than the first beam pattern 30. When the electrically controllable light scattering device 36 is in the light scattering state 38, the light 24 leaving the electrically controllable light scattering device 36 is diffused compared to the light 24 entering electrically controllable light scattering device 36.

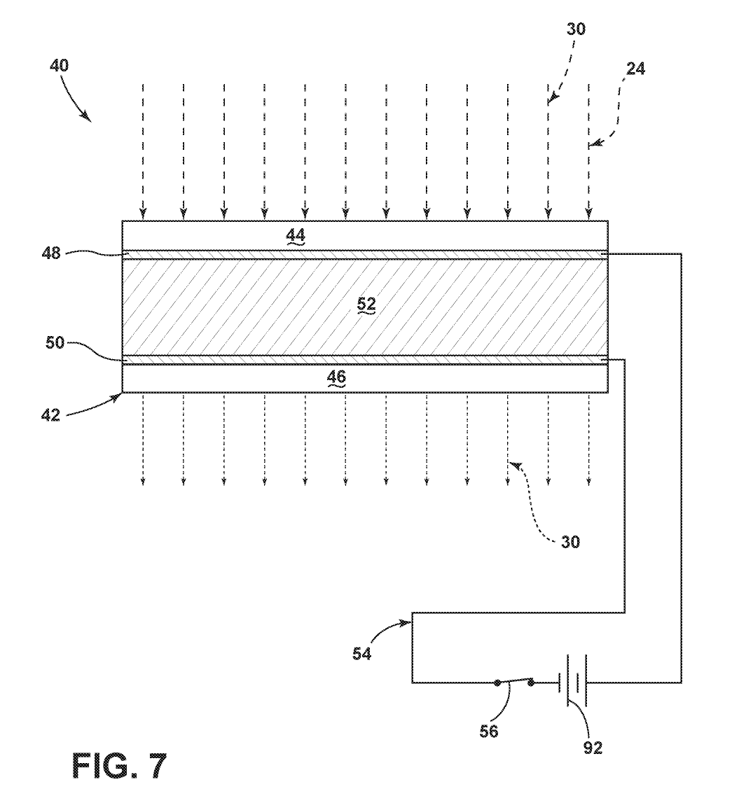

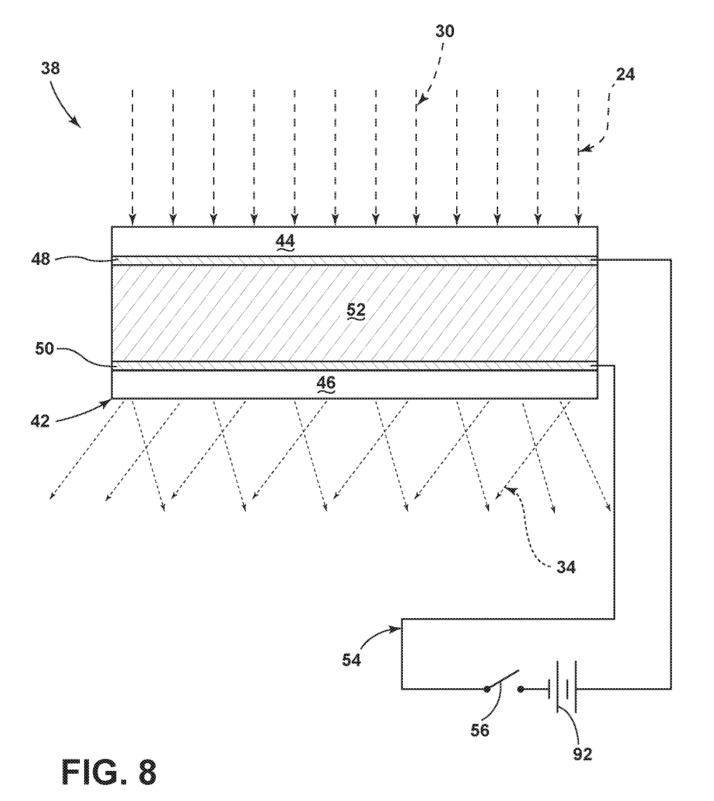

Referring to FIGS. 7-8, the electrically controllable light scattering device 36 can be a polymer dispersed liquid crystal device 42 as mentioned above. Generally, the polymer dispersed liquid crystal device 42 has a first portion 44 and a second portion 46 opposite the first portion 44. Both the first portion 44 and the second portion 46 are typically clear glass or plastic. The polymer dispersed liquid crystal device 42 further has a first clear conductive layer 48 next to the first portion 44 and a second clear conductive layer 50 next to the second portion 46. The polymer dispersed liquid crystal device 42 further has a central cavity 52 that includes polymer dispersed liquid crystals between the first clear conductive layer 48 and the second clear conductive layer 50. When a power source 92 is connected and applied to the first clear conductive layer 48 and the second clear conductive layer 50, an electrical field is created between the first clear conductive layer 48 and the second clear conductive layer 50. The electrical field causes the polymer dispersed liquid crystals in the central cavity 52 to align with the electrical field and thus allow the light 24 entering the polymer dispersed liquid crystal device 42 with the first beam pattern 30 to exit the polymer dispersed liquid crystal device 42 essentially still with the first beam pattern 30. In other words, when the power source 92 is applied to the polymer dispersed liquid crystal device 42, the polymer dispersed liquid crystal device 42 is in the non-light scattering state 40 (see FIG. 7). The power source 92 can be a battery in electrical communication with the polymer dispersed liquid crystal device 42 through a circuit 54, which can be opened or closed via a switch 56. In the non-light scattering state 40, the switch 56 is closed. Alternatively, when the switch 56 is open (see FIG. 8) and thus a power source is not applied to the first clear conductive layer 48 and the second clear conductive layer 50, an electrical field is not created between the first clear conductive layer 48 and the second clear conductive layer 50. Thus, there is no electrical field to cause the polymer dispersed liquid crystals in the central cavity 52 to align and thus the polymer dispersed liquid crystals scatter the light 24 that had entered the polymer dispersed liquid crystal device 42 with the first beam pattern 30. Therefore, when the power source 92 is not applied to the polymer dispersed liquid crystal device 42, the polymer dispersed liquid crystal device 42 is in the light scattering state 38 and the polymer disperse liquid crystals in the central cavity 52 scatter the entering light 24, causing the light to exit with a second beam pattern 34, i.e., a wider or more diffused, pattern.

When the electrically controllable light scattering device 36 is in the non-light scattering state 40, the light 24 leaving the electrically controllable light scattering device 36 with the first beam pattern 30 serves as light for reading, as discussed above. Alternatively, when the electrically controllable light scattering device 36 is in the light scattering state 38, the light 24 leaving the electrically controllable light scattering device 36 serves as ambient light, as discussed above.

With light assembly 14 and the alternative embodiment light assembly 14A, the light source 22 is capable of emitting light 24 of more than one color, that is, in multiple colors. In other words, the light source 22 can emit light 24 of a first color. The light source 22 can subsequently not emit light 24 of the first color and emit light 24 of a second color (or third color, fourth color, etc.) instead. The light source 22 can be one or more LEDs. More specifically, the light source 22 can be one or more RGB LEDs. In the embodiment illustrated in FIGS. 3-4 with light assembly 14, the light source 22 is an RGB LED. Utilizing an RGB LED allows the light source 22 to emit white light as well as light of many different colors through the adjustment of the current supplied to each of the red, green, and blue portions of the RGB LED. Alternatively, the light source 22 can be an array of LEDs, with a variety of individual LEDs of individual colors and a white light emitting LED. Thus, for example, if a blue light is desired to be emitted, then the blue LED of the array of LEDs could be activated, and so on for each color.

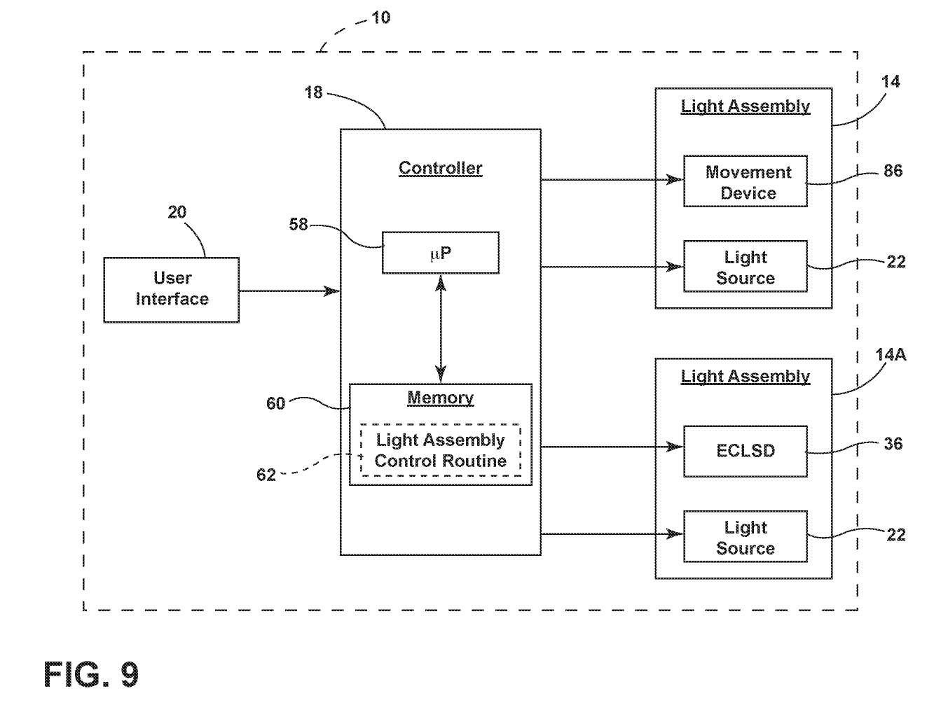

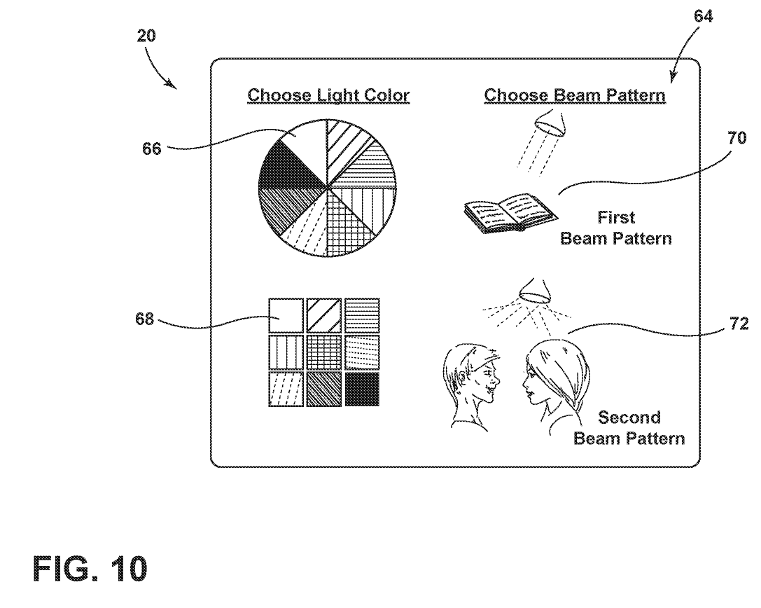

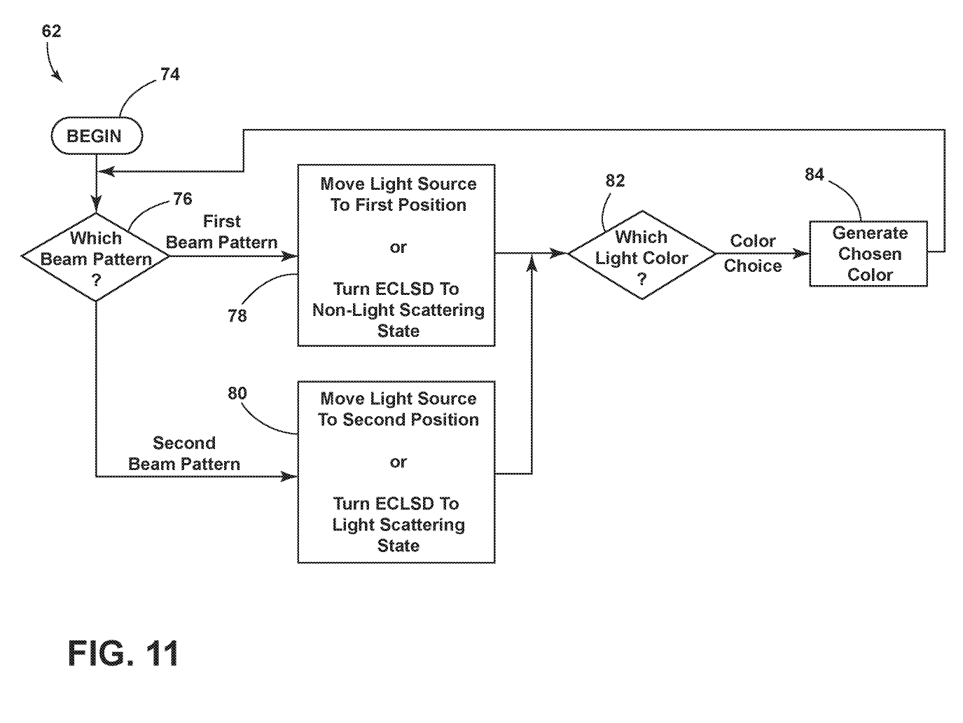

The light source 22 emits light 24 that exits the light assembly 14 (or the alternative embodiment light assembly 14A) and enters the interior 12 of the vehicle 10 with either the first beam pattern 30 or the second beam pattern 34. Referring now to FIGS. 9-11, the controller 18 controls whether the light 24 that exits the light assembly 14 (or the alternative embodiment light assembly 14A) and enters the interior 12 of the vehicle has either the first beam pattern 30 or the second beam pattern 34 and controls which color of the multiple colors the light source 22 emits.

The controller 18 may include control circuitry such as a microprocessor 58 and memory 60. The memory 60 stores and the microprocessor 58 executes a light assembly control routine 62.

The user interface 20 allows a passenger of the vehicle 10 to select a color of the multiple colors that the light source 22 is able to emit. For example, the user interface 20 could be a touch screen 64 that produces a graphical representation of a color wheel 66 or various specific colors 68. The passenger could then select by touching the color wheel 66 or the various specific colors 68 in the spot producing the color that the passenger wants the light source 22 to emit. The user interface 20 provides the selection as input into the controller 18. The controller 18 in turn causes the light source 22 to emit light 24 in the color the passenger selected on the touch screen 64.

In addition, the user interface 20 further allows the passenger to select whether the light 24 enters the interior 12 with the first beam pattern 30 or the second beam pattern 34. For example, the touch screen 64 of the user interface 20 could produce a graphical representation 70 of light with the first beam pattern 30 shining on reading material. The passenger could then select by touching the graphical representation 70 and the user interface 20 provides that selection as input to the controller 18. The controller 18 in turn causes the light source 22 to emit light 24 with the first beam pattern 30 by causing the light source 22 of the light assembly 14 to be in the first position 28 by manipulating movement device 86 or, if the alternative embodiment light assembly 14A is used instead, by causing the electrically controllable light scattering device (“ECLSD”) 36 to be in the non-light scattering state 40. The touch screen 64 of the user interface 20 could additionally produce a graphical representation 72 of light 24 with the second beam pattern 34. The passenger could then select by touching the graphical representation 72, and the user interface 20 provides that selection as input to the controller 18. The controller 18 in turn causes the light source 22 to emit light 24 with the second beam pattern 34 by causing the light source 22 of the light assembly 14 to be in the second position 32 by manipulating movement device 86 or, if alternative embodiment light assembly 14A is used, by causing the electrically controllable light scattering device 36 to be in the light scattering state 38.

More specifically, assuming that the light source 22 has been activated (i.e., is emitting light 24), microprocessor 58 executes light assembly control routine 62. Light assembly control routine 62 begins at step 74 and proceeds to step 76, to ascertain which beam pattern (first beam pattern 30 or second beam pattern 34) for the light 24 has been selected. As discussed above, this selection can be made via the user interface 20. Alternatively, the selection can be made via the use of switches, knobs, or buttons. If the first beam pattern 30 has been selected, then the light assembly control routine 62 proceeds to step 78 to either (a) move the light source 22 of light assembly 14 to the first position 28, or (b) cause the electrically controllable light scattering device 36 of light assembly 14A to be in the non-light scattering state 40. Alternatively, if the second beam pattern 34 has been selected, then the light assembly control routine 62 proceeds to step 80 to either (a) move the light source 22 of light assembly 14 to the second position 32, or (b) cause the electrically controllable light scattering device 36 of light assembly 14A to be in the light scattering state 38. The light assembly control routine 62 then proceeds to step 82 to ascertain which color has been chosen for the light source 22 to emit. As discussed above, this selection can be made via the user interface 20. Alternatively, the selection can be made via the use of switches, knobs, or buttons. The light assembly control routine 62 then proceeds to step 84 to cause the light source 22 to generate the chosen color. The light assembly control routine 62 then returns to step 74 (i.e., the beginning).

Thus, one light assembly (whether light assembly 14 or light assembly 14A) in a vehicle can provide both functional light (i.e., light for reading) and ambient light (i.e., mood lighting) in a variety of colors.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A light assembly for emitting light into an interior of a vehicle comprising:
a light source capable of emitting light of more than one color;
an optical device in optical relation to the light source such that the light transmits through or within the optical device;
the light source having a first position relative to the optical device such that the light transmitted through or within the optical device leaves the optical device with a first beam pattern; and
the light source having a second position relative to the optical device such that the light transmitted through or within the optical device leaves the optical device with a second beam pattern.

2. The light assembly of claim 1, wherein the light source is one or more LEDs.

3. The light assembly of claim 1, wherein, in the first position, the light leaving the optical device serves as light for reading.

4. The light assembly of claim 3, wherein, in the second position, the light leaving the optical device serves as ambient lighting.

5. A light assembly for emitting light into an interior of a vehicle comprising:
a light source capable of emitting light of more than one color;
an optical device in optical relation to the light source such that the light transmits through or within the optical device and leaves the optical device with a first beam pattern;
an electrically controllable light scattering device in optical relation to the optical device such that the light that has left the optical device with the first beam pattern transmits through the electrically controllable light scattering device;
wherein the electrically controllable light scattering device has a light scattering state and a non-light scattering state;
wherein, in the non-light scattering state, the electrically controllable light scattering device allows the light that transmits through the electrically controllable light scattering device to leave the electrically controllable light scattering device with the first beam pattern;
wherein, in the light scattering state, the electrically controllable light scattering device causes the light that transmits through the electrically controllable light scattering device to leave the electrically controllable light scattering device with a second beam pattern.

6. The light assembly for emitting light into an interior of a vehicle of claim 5,
wherein the electrically controllable light scattering device is a polymer dispersed liquid crystal device;
wherein in the non-light scattering state, an electrical potential is applied to the polymer dispersed liquid crystal device; and
wherein in the light scattering state, an electrical potential is not applied to the polymer dispersed liquid crystal device.

7. The light assembly for emitting light into an interior of a vehicle of claim 6, wherein, in the non-light scattering state, the light leaving the polymer dispersed liquid crystal device serves as light for reading.

8. The light assembly for emitting light into an interior of a vehicle of claim 7, wherein, in the light scattering state, the light leaving the polymer dispersed liquid crystal device serves as ambient light.

9. The light assembly for emitting light into an interior of a vehicle of claim 5, wherein the light source is one or more LEDs.

10. A vehicle comprising:
an interior;
a light assembly capable of emitting light with both a first beam pattern and a second beam pattern to the interior,
the light assembly comprising a light source, capable of emitting light in multiple colors, that emits light that exits the light assembly and enters the interior of the vehicle with either the first beam pattern or the second beam pattern; and
a controller that controls whether the light that exists the light assembly and enters the interior of the vehicle has either the first beam pattern or the second beam pattern and controls which color of the multiple colors the light source emits.

11. The vehicle of claim 10 further comprising a user interface in communication with the controller, wherein the user interface is usable from the interior and allows a passenger of the vehicle to select a color of the multiple colors of the light.

12. The vehicle of claim 11, wherein the user interface further allows the passenger to select whether the light enters the interior with the first beam pattern or with the second beam pattern.

13. The vehicle of claim 12, wherein the vehicle is transporting a passenger autonomously, and the light that enters the interior of the vehicle is in the first beam pattern for purposes of providing light for the passenger to read.

14. The vehicle of claim 12, wherein the light source is one or more LEDs and the optical device is a lens.

15. The vehicle of claim 14, wherein the one or more LEDs include one or more RGB LEDs.

16. The vehicle of claim 15, the interior of the vehicle comprising a ceiling, wherein the light source is positioned at the ceiling.

17. The vehicle of claim 12, the light assembly further comprising:
an optical device in optical relation to the light source such that the light transmits through or within the optical device;
the light source having a first position relative to the optical device such that the light transmitted through or within the optical device leaves the optical device with the first beam pattern; and
the light source having a second position relative to the optical device such that the light transmitted through or within the optical device leaves the optical device with the second beam pattern that is wider than compared to the first beam pattern;
wherein the controller controls whether the light source is in the first position or the second position based on a selection made on the user interface as to whether the light enters the interior with the first beam pattern or with the second beam pattern.

18. The vehicle of claim 12, the light assembly further comprising:
an optical device in optical relation to the light source such that the light transmits through or within the optical device and leaves the optical device with the first beam pattern; and
an electrically controllable light scattering device in optical relation to the optical device such that the light that has left the optical device with the first beam pattern transmits through the electrically controllable light scattering device;
wherein the electrically controllable light scattering device has a light scattering state and a non-light scattering state;
wherein, in the non-light scattering state, the electrically controllable light scattering device allows the light that transmits through the electrically controllable light scattering device to leave the electrically controllable light scattering device with the first beam pattern;
wherein, in the light scattering state, the electrically controllable light scattering device causes the light that transmits through the electrically controllable light scattering device to leave the electrically controllable light scattering device with the second beam pattern; and
wherein the controller controls whether the electrically controllable light scattering device is in the non-light scattering state or the light scattering state based on a selection made on the user interface as to whether the light enters the interior with the first beam pattern or with the second beam pattern.

19. The vehicle of claim 18, wherein the electrically controllable light scattering device is a polymer dispersed liquid crystal device.

20. The vehicle of claim 19, wherein the light source includes one or more RGB LEDs.
